(19) United States
(12) Patent Application Publication
(10) Pub. No.: US 2026/0038827 A1
(43) Pub. Date: Feb. 5, 2026

(54) LITHIUM-EXCESS, POLYANIONIZED, ROCKSALT CATHODE FOR RECHARGEABLE LITHIUM-ION BATTERIES

(71) Applicant: Massachusetts Institute of Technology, Cambridge, MA (US)

(72) Inventors: Ju Li, Weston, MA (US); Yanhao Dong, Fremont, CA (US); Yimeng Huang, Cambridge, MA (US)

(73) Assignee: Massachusetts Institute of Technology, Cambridge, MA (US)

(21) Appl. No.: 18/790,946

(22) Filed: Jul. 31, 2024

(51) Int. Cl. H01M 4/58; C01B 25/45; C01B 33/32; C01B 35/12; H01M 4/02; H01M 10/0525; H01M 10/0568; H01M 10/0569

(52) U.S. Cl. CPC H01M 4/5825; C01B 25/45; C01B 33/32; C01B 35/128; H01M 10/0525; H01M 10/0568; H01M 10/0569; C01P 2002/32; C01P 2002/72; C01P 2002/82; C01P 2002/85; C01P 2004/03; C01P 2004/04; C01P 2006/40; H01M 2004/028; H01M 2300/0028

(57) ABSTRACT

Disclosed herein is a cathode for a lithium-ion battery having a formula:

Li₂₊ᵤ₋ᵥM₂₋ᵤ[XO₄]ₓO₄₍₁₋ₓ₎ where, 0≤u≤1, 0≤v≤2 and 0≤x≤1, wherein M is a transition metal element of manganese or a mixture of manganese and iron, and X is an element of phosphorus, silicon, sulfur, boron, or a mixture of these elements.

### CROSS-REFERENCE SECTION

N/A

### STATEMENT REGARDING FEDERALLY SPONSORED RESEARCH

N/A

### FIELD

Disclosed herein is a family of lithium-excess manganese-rich cathodes with spinel-like cation ordering that hybridize rocksalt- and polyanion-type structures. More particularly, a rational amount of XO₄ (X=P, Si, S, B) polyanion unit is incorporated in a Li-M-O rocksalt structure (M=Mn, Fe) to form a cathode with formula Li₂₊ᵤ₋ᵥM₂₋ᵤ[XO₄]ₓO₄₍₁₋ₓ₎ where the optimal values are x=0.17, u=0.5 and v=0.83. The partial polyanionization suppresses percolating lattice oxygen loss in high-voltage (e.g., greater than or equal to 4.5 V vs. Li/Li⁺) cathodes, enabling stable cycling at 4.8 V vs. Li/Li⁺ while having initial discharge energy densities above 1100 Wh kg⁻¹.

### BACKGROUND

Rapid growth of electricity storage capabilities with lithium-ion batteries (LIBs) is required to realize a sustainable energy infrastructure. In terms of resource availability, Co is ˜5× the price of Li on a molar basis, and Ni is ˜2×, thus a crisis for the supply of Co or Ni would arise before one for Li. For advanced LIB oxide cathodes, eliminating Co and Ni usage (especially Co) would greatly improve the scalability of electricity storage. Disordered rocksalt (DRX) cathodes are quite attractive for being Co/Ni-free, while having high energy densities approaching 1100 Wh kg⁻¹.

### SUMMARY

On the other hand, to reach high energy densities (>900 Wh kg⁻¹), high upper cutoff voltages e.g., 4.8 V vs. Li/Li⁺ for DRX are required for cathodes, which means highly delithiated states with most of the Li⁺-hosting sites vacant. This often triggers the participation of oxygen anion redox and eventually irreversible oxygen loss.

A heavy usage of hybrid anion- and cation-redox (HACR) with more exotic oxygen valence O^{α-} (α<2) challenges the cycling stability of the cathode since O^{α-} tends to be more mobile, leading to percolating lattice oxygen diffusion to the reactive surface, extensive side reactions with the electrolyte, and finally structural and chemical instability at the surface and in the bulk. These are possible issues for DRX and other high energy density cathodes. In contrast, polyanion olivine cathodes such as LiFePO₄ have good structural, electrochemical and thermal stability, as well as exceptional cycling performance, due to strong covalent bonding in the PO₄ polyanion structural unit that improves structural integrity. Good structural, electrochemical and thermal stability compared to other types of cathodes (e.g., layered, disordered rock salt cathodes).

To gain energy density-stability synergy, it would be ideal to integrate the stability-enhancing polyanion groups XO₄ (X=P, Si, S, B) into the high-energy-density HACR cathode framework, especially Co/Ni-free DRX (FIG. 1, middle panel). Oxide ions within the polyanion group are strongly bound to X via covalent bond such that long-range percolation of lattice oxygen diffusion/loss is suppressed (FIG. 1, right panel). Since polyanions could impose penalties on diffusion kinetics and capacity, only partial polyanionization is needed for effective stabilization to ensure large reversible capacity. The solid solution with polyanions seems plausible considering the structural similarity between olivine (hexagonal close-packed, HCP, anion sublattice) and rocksalt derivatives (including layered, DRX and spinel cathodes, all with face-centered cubic, FCC, anion sublattice). The subtle differences lie at different stacking sequence of anions and cation filling configurations (FIG. 2). However, there are only a few experimental realizations of bulk polyanion incorporation in DRX-type structure and the cycling stability remains a problem.

The underlying obstacles of making an anionic random solid solution between the more inert XO₄ polyanions and “normal 0” anions in the rocksalt lattice are two-fold. First, while P prefers tetrahedral interstitial sites and does not site-compete with Li/M or O on octahedral sites, there is a large difference in the tetrahedra size defined by the O—O distance between polyanion olivine and rocksalt-type cathodes. The true tetrahedra size calculated from the P—O bond length for polyanion olivine cathodes is 12-15% smaller than that for rocksalt-type cathodes (FIG. 3). This would result in lattice distortion and thus difficulty in making a solid-solution phase between XO₄ polyanions and “normal 0” anions. Thus, typical high-temperature (e.g., above about 600° C.) solid-state synthesis would not work, and often it is needed to resort to lower-temperature (e.g., below about 600° C.) mechano-chemical synthesis.

Second, for each XO₄ tetrahedron, cation occupancy (Li or M) in the four neighboring face-sharing octahedral sites may be excluded for electrostatic considerations, as in the case for LiFePO₄. Thus, the octahedral cation sublattice may have a certain number of vacancies, represented by v in Li₂₊ᵤ₋ᵥM₂₋ᵤ[XO₄]ₓO₄₍₁₋ₓ₎, with v>4x (FIG. 4).

Accordingly, there remains a need for a cathode active material with integration of XO₄ polyanions into high-capacity rocksalt structures for achieving both high energy density and improved cycling stability. Disclosed herein is a cathode for a lithium-ion battery. The cathode has the formula:

Li₂₊ᵤ₋ᵥM₂₋ᵤ[XO₄]ₓO₄₍₁₋ₓ₎ where, 0≤u≤1, 0≤v≤2 and 0≤x≤1, wherein M is a transition metal element of manganese or a mixture of manganese and iron, and X is an element of phosphorus, silicon, sulfur, boron, or a mixture of these elements.

Also disclosed herein is a battery having a cathode comprising Li₂₊ᵤ₋ᵥM₂₋ᵤ[XO₄]ₓO₄₍₁₋ₓ₎ where, 0≤u≤1, 0≤v≤2 and 0≤x≤1, wherein M is a transition metal element of manganese, or a mixture of manganese and iron, and X is an element of phosphorus, silicon, sulfur, boron, or a mixture of these elements; a separator; an electrolyte; an anode; and a cell case.

Also disclosed herein is a method of preparing a cathode including the steps of: (1) providing ingredients of Li₂O, Mn₂O₃, MnO₂, Li₃PO₄, Fe₂O₃, B₂O₃, Li₂SO₄ and SiO₂: (2) mixing the ingredients in a mixer for a sufficient period to form Li₂₊ᵤ₋ᵥM₂₋ᵤ[XO₄]ₓO₄₍₁₋ₓ₎ where, 0≤u≤1, 0≤v≤2 and 0≤x≤1, wherein M is a transition metal element of manganese, or a mixture of manganese and iron, and X is an element of phosphorus, silicon, sulfur, boron, or a mixture of these elements.

Other features and advantages of the disclosure will be apparent from the following specification taken in conjunction with the following Figures.

### BRIEF DESCRIPTION OF THE DRAWINGS

To understand the present disclosure, it will now be described by way of example, with reference to the accompanying drawings in which:

FIG. 1 is a schematic representation of the structures of M₂O₄, M₂₋ᵤO₄, and M₂₋ᵤ[XO₄]ₓO₄₍₁₋ₓ₎.

FIG. 2 is a schematic representations of HCP and FCC oxygen sublattice, and cation filling configurations for olivine, layered, DRX and spinel cathodes (unit cells are marked by a dashed lines).

FIG. 3 is a comparison of crystallographic tetrahedra size for polyanion olivine and rocksalt-type cathodes. LMO: LiMn₂O₄, LNMO: LiNi_{0.5}Mn_{1.5}O₄, LCO: LiCoO₂, NCM111: LiNi_{1/3}Co_{1/3}Mn_{1/3}O₂, LNO: LiNiO₂.

FIG. 4 is a schematic representation of the occupancy of Li/Mn in octahedron corner-shared to a polyanion tetrahedron and vacant octahedron face-shared to a polyanion tetrahedron.

FIG. 5 is a schematic representation of spinel-type ordering of transition metal ions.

FIG. 6 is a schematic representation of different oxygen local environments, including bonded oxide ions (O—X and O-3M) and underbonded oxide ions (0-3M′, O-2M, O-1M, and O-0M).

FIG. 7 is a plot of bonded O (O_{B}) ratio in stoichiometries with different theoretical lithiation limits 2+u−(v-t)ₘᵢₙ. Line 70 represents polyanion-free compositions, and the line 72 represents polyanionic compositions (with u=0.5). The dashed line marks the percolation threshold for underbonded 0, above which (<20% O_{UB}) compositions are considered to have good cycling stability.

FIG. 8A shows xₘₐₓ and xₘᵢₙ of Li₂₊ᵤ₋ᵥM₂₋ᵤ[XO₄]ₓO₄₍₁₋ₓ₎ limits under different Li and M content.

FIG. 8B shows the projection of plot in (FIG. 8a) onto the x-y plane, showing different regimes of polyanion stabilization for different base compositions. Base compositions of Li_{2.5-v}Mn_{1.5}P_{0.17}O₄ (v=−0.17, 0.17, 0.5, 0.83, 1.17) and Li_{1.17+u}Mn₂₋ᵤP_{0.22-0.11u}O₄ (u=0.2, 0.35, 0.5, 0.65, 0.8) are marked.

FIG. 9 shows a structural model of Li_{1.67}Mn_{1.5}P_{0.17}O₄.

FIG. 10A shows the XRD patterns of Li_{1.67}Mn_{1.5}P_{0.17}O₄ (open circles are experimental and the solid line is calculated).

FIG. 10b shows the pair distribution function of Li_{1.67}Mn_{1.5}P_{0.17}O₄.

FIG. 11 shows the Raman spectroscopy data of Li_{1.67}Mn_{1.5}P_{0.17}O₄. Peaks are marked by their corresponding bonds.

FIG. 12 shows the high-angle annular dark field imaging scanning transmission electron microscopy (HAADF-STEM) images of Li_{1.67}Mn_{1.5}P_{0.17}O₄. Scale bar, 1 nm. Image on the right is filtered for increased visibility of the atomic positions.

FIG. 13a shows the scanning electron microscopy (SEM) image of Li_{1.67}Mn_{1.5}P_{0.17}O₄. Scale bar, 200 nm.

FIG. 13b shows the scanning transmission electron microscopy elemental dispersive (STEM-EDS) mapping of Li_{1.67}Mn_{1.5}P_{0.17}O₄. Scale bar, 100 nm.

FIG. 13c shows the transmission electron microscopy (TEM) image of Li_{1.67}Mn_{1.5}P_{0.17}O₄. Scale bar, 5 nm. Inset: selected area electron diffraction (SAED) pattern. Scale bar, 2 nm⁻¹.

FIG. 14a shows the voltage profiles of Li_{1.67}Mn_{1.5}P_{0.17}O₄ in the initial two formation cycles between 1.5-4.8 V vs. Li/Li⁺ at 20 mA g⁻¹.

FIG. 14b shows the capacity from FIG. 14a converted to Li content n.

FIG. 15 shows the rate performance test of Li_{1.67}Mn_{1.5}P_{0.17}O₄ under at 20, 50, 200, 500 and 1000 mA g⁻¹ (the same cell was used). Inset: Voltage profiles of the first cycle at 20, 50, 200, 500 and 1000 mA g⁻¹.

FIG. 16 shows the discharge capacity (top) and average discharge voltage (bottom) retention of Li_{1.67}Mn_{1.5}P_{0.17}O₄, Li_{1.67}Mn_{1.5}Nb_{0.17}O₄ and Li_{1.93}Mn_{1.65}O₄ in 100 cycles between 1.5-4.8 V vs. Li/Li⁺ at 50 mA g⁻¹, following the two initial formation cycles at 20 mA g⁻¹ (not shown).

FIG. 17a shows the XRD patterns of Li_{1.67}Mn_{1.67-x}PₓO₄ (0≤x≤0.5).

FIG. 17b shows the discharge energy density of Li_{1.67}Mn_{1.67-x}PₓO₄ (0≤x≤0.5) in the first 100 cycles, between 1.5-4.8 V vs. Li/Li⁺ at 50 mA g⁻¹, after two formation cycles at 20 mA g⁻¹ (not shown).

FIG. 17c shows the discharge energy densities of Li_{1.67}Mn_{1.67-x}PₓO₄ (0≤x≤0.5) taken at the 25^{th} cycle (counted after the two formation cycles). The dashed line indicates the benchmark value for comparison.

FIG. 17d shows the discharge energy densities of Li_{1.67}Mn_{1.67-x}PₓO₄ (0≤x≤0.5) taken at the 100^{th} cycle (counted after the two formation cycles). The dashed rectangle indicates the predicted optimal range of x calculated from design.

FIG. 18A shows the XRD patterns of Li_{2.5-v}Mn_{1.5}P_{0.17}O₄ (v=−0.17, 0.17, 0.5, 0.83, 1.17). Note that the XRD pattern for DRX LiMnO₂ is calculated from the configuration of a completely random distribution of Li and Mn in 16c and 16d octahedral sites.

FIG. 18b shows the discharge energy density of Li_{2.5-v}Mn_{1.5}P_{0.17}O₄ (v=−0.17, 0.17, 0.5, 0.83, 1.17) in the first 100 cycles, between 1.5-4.8 V vs. Li/Li⁺ at 50 mA g⁻¹, after two formation cycles at 20 mA g⁻¹ (not shown).

FIG. 18c shows the discharge energy densities of Li_{2.5-v}Mn_{1.5}P_{0.17}O₄ (v=−0.17, 0.17, 0.5, 0.83, 1.17) taken at the 25^{th} cycle (counted after the two formation cycles). The dashed line indicates the benchmark value for comparison.

FIG. 19A shows the XRD patterns of Li_{1.17+u}Mn₂₋ᵤP_{0.22-0.11u}O₄ (u=0.2, 0.35, 0.5, 0.65, 0.8). Note that the XRD pattern for DRX LiMnO₂ is calculated from the configuration of a completely random distribution of Li and Mn in 16c and 16d octahedral sites.

FIG. 19b shows the discharge energy density of Li_{1.17+u}Mn₂₋ᵤP_{0.22-0.11u}O₄ (u=0.2, 0.35, 0.5, 0.65, 0.8) in the first 100 cycles, between 1.5-4.8 V vs. Li/Li⁺ at 50 mA g⁻¹, after two formation cycles at 20 mA g⁻¹ (not shown).

FIG. 19c shows the discharge energy densities of Li_{1.17+u}Mn₂₋ᵤP_{0.22-0.11u}O₄ (u=0.2, 0.35, 0.5, 0.65, 0.8) taken at the 25^{th} cycle (counted after the two formation cycles). The dashed line indicates the benchmark value for comparison.

FIG. 20a shows the voltage profiles of Li_{1.67}Mn_{1.25}Fe_{0.25}P_{0.17}O₄ in the initial two formation cycles between 1.5-4.8 V vs. Li/Li⁺ at 20 mA g⁻¹.

FIG. 20b shows the capacity from FIG. 20a converted to Li content n.

FIG. 21a shows the rate performance of Li_{1.67}Mn_{1.25}Fe_{0.25}P_{0.17}O₄ under at 20, 50, 200, 500 and 1000 mA g⁻¹ (the same cell was used).

FIG. 21b shows the discharge capacity and discharge energy density retention of Li_{1.67}Mn_{1.25}Fe_{0.25}P_{0.17}O₄ in 100 cycles between 1.5-4.8 V vs. Li/Li⁺ at 50 mA g⁻¹, following the two initial formation cycles at 20 mA g⁻¹ (not shown).

FIG. 22a shows the XRD patterns of Li_{1.67}Mn_{1.5}B_{0.17}O₄, Li_{1.67}Mn_{1.5}Si_{0.17}O₄, Li_{1.67}Mn_{1.5}S_{0.17}O₄ (orange/green/purple open circles are experimental and solid lines are calculated), and spinel LiMn₂O₄ and LiNi_{0.5}Mn_{1.5}O₄ references, and MnO₂ precursor.

FIG. 22b shows the SEM image of Li_{1.67}Mn_{1.5}B_{0.17}O₄. Scale bar, 200 nm.

FIG. 22c shows the EDS mapping of Li_{1.67}Mn_{1.5}B_{0.17}O₄. Scale bar, 100 nm.

FIG. 22d shows the TEM image of Li_{1.67}Mn_{1.5}B_{0.17}O₄. Scale bar, 5 nm. Inset: SAED pattern. Scale bar, 2 nm⁻¹.

FIG. 22e shows the voltage profiles of Li_{1.67}Mn_{1.5}B_{0.17}O₄, Li₅Mn_{4.5}Si_{0.5}O₁₂ and Li₅Mn_{4.5}S_{0.5}O₁₂ in the initial two formation cycles between 1.5-4.8 V vs. Li/Li⁺ at 20 mA g⁻¹.

FIG. 22f and FIG. 22g show the discharge capacity and discharge energy density retention, respectively, of Li_{1.67}Mn_{1.5}P_{0.17}O₄, Li_{1.67}Mn_{1.5}B_{0.17}O₄, Li_{1.67}Mn_{1.5}Si_{0.17}O₄, Li_{1.67}Mn_{1.5}S_{0.17}O₄ and Li_{1.67}Mn_{1.67}O₄ in 100 cycles between 1.5-4.8 V vs. Li/Li⁺ at 50 mA g⁻¹, following the two initial formation cycles at 20 mA g⁻¹ (not shown).

FIG. 23 is an exemplary schematic of a battery including the disclosed cathode.

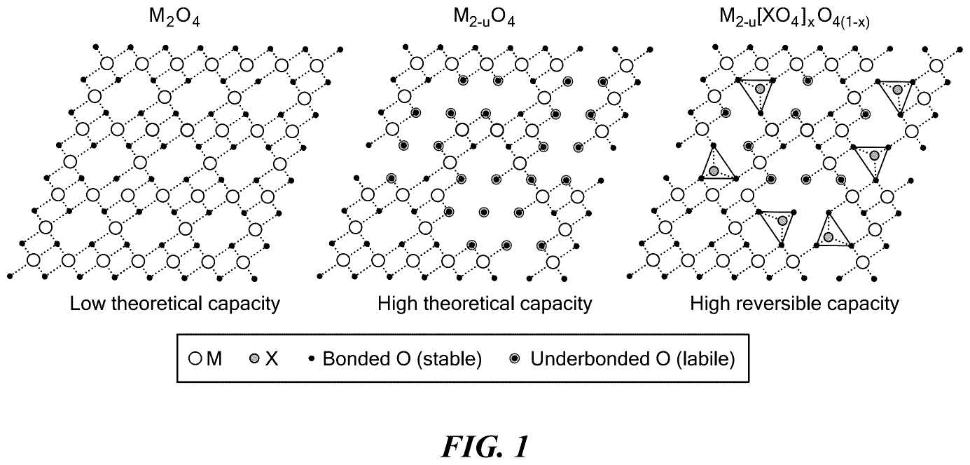

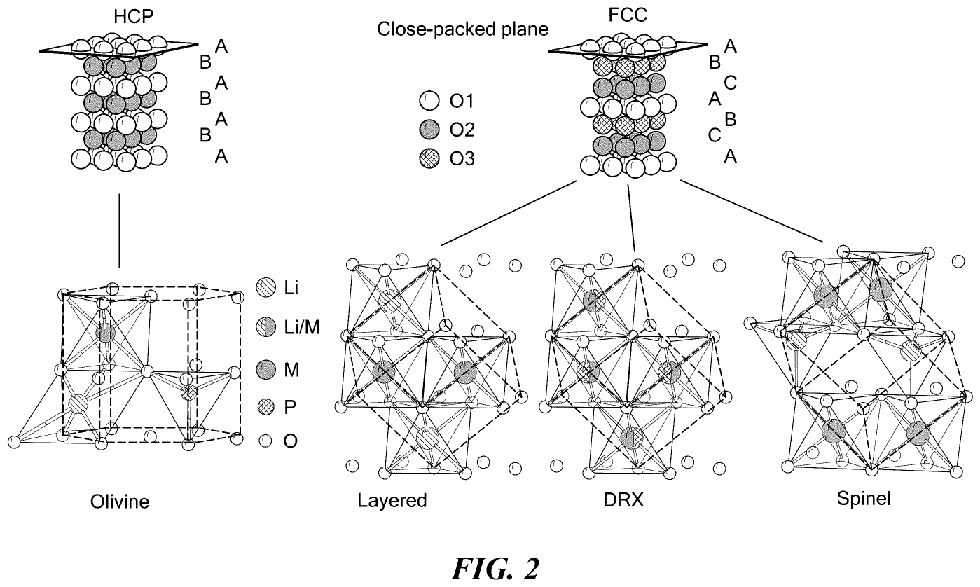

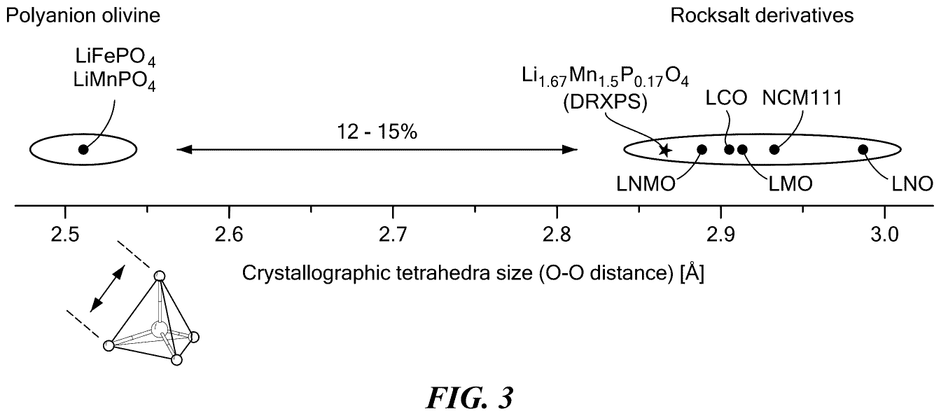

### DETAILED DESCRIPTION

While this disclosure is susceptible of embodiments in many different forms, there is shown in the drawings and will herein be described in detail preferred embodiments of the disclosure with the understanding that the present disclosure is to be considered as an exemplification of the principles of the disclosure and is not intended to limit the broad aspect of the disclosure to the embodiments illustrated.

The present disclosure seeks to integrate polyanion units into rocksalt structures for a battery cathode material with high energy density and improved cycling stability under high voltages. The inventors produced a family of Li-excess Co/Ni-free disordered rocksalt-polyanionic spinel (DRXPS) cathodes, with a general chemical formula of Li₂₊ᵤ₋ᵥM₂₋ᵤ[XO₄]ₓO₄₍₁₋ₓ₎, where M can be transition metals such as Mn and Fe, or their mixtures, X can be polyanion elements such as P, Si, S, B, or a mixture of these elements. u, v, and x describe the designed stoichiometries, and are typically within the range of 0≤u≤1, 0≤v≤2 and 0≤x≤1. This family of compounds is called DRXPS because they are designed on a parent DRX structure and have bulk polyanion incorporation and spinel-type cation ordering (that gives spinel diffraction pattern). The appropriate chemistry Li₂₊ᵤ₋ᵥM₂₋ᵤ[XO₄]ₓO₄₍₁₋ₓ₎ for high capacity (e.g., greater than about 300 mAh g⁻¹)/energy density (e.g., greater than about 900 Wh kg⁻¹), bulk polyanion (XO₄ group, X=P, Si, S, B) incorporation and stabilized lattice oxygen for synthesizable DRXPS cathodes with the following considerations:

In relation to cation filling: with an FCC oxygen framework, assume octahedral site occupancy for M, tetrahedral or octahedral site occupancy for Li, and tetrahedral site occupancy for X (this holds for P, Si and S, and is a simplification for B as it may also form trigonal planar BO₃).

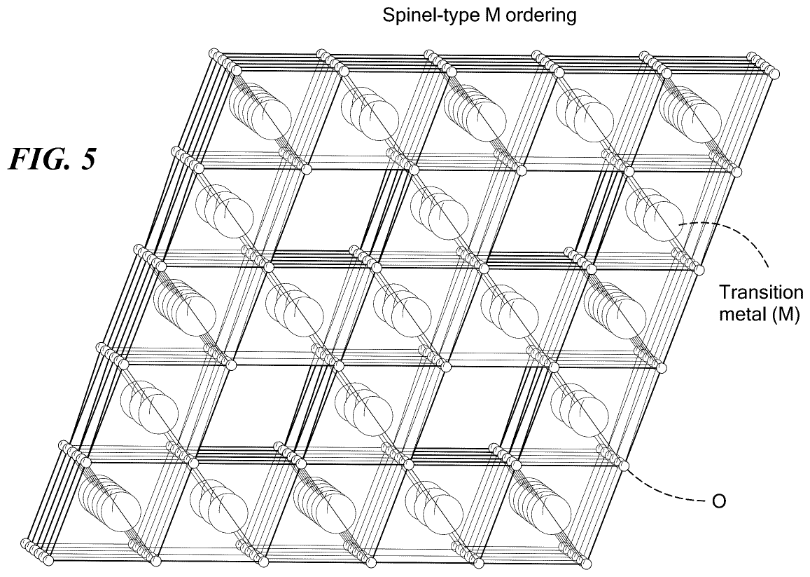

In relation to spinel-type transition metal ordering: a spinel-type M ordering is preferred to fully utilize M 3d-O 2p hybridization to stabilize the oxygen framework and to provide 3-dimensional (3D) channels for Li⁺ diffusion (FIG. 5). This can be realized in a spinel structure with LiM₂O₄ stoichiometry, a rocksalt structure with Li_{[16c]}M_{[16d]}O₂ stoichiometry, or their composites.

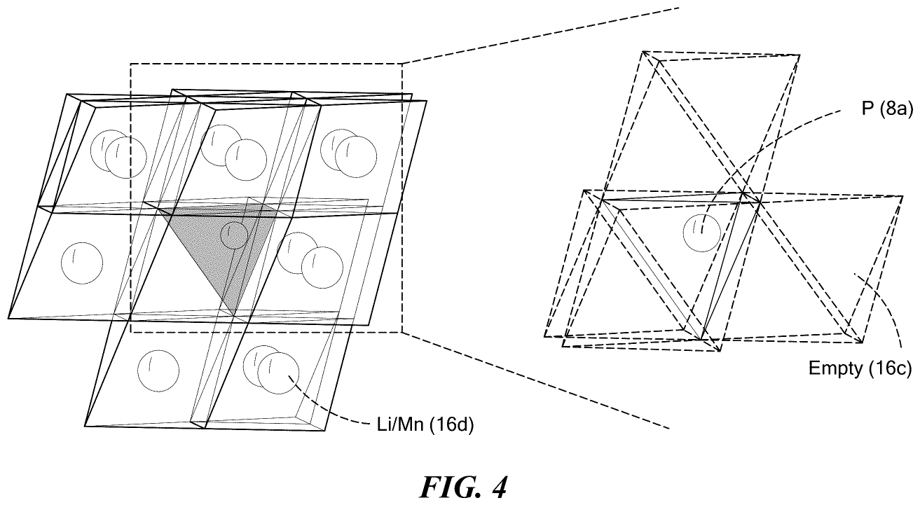

In relation to cation deficiency: to successfully incorporate polyanions into the lattice, the four octahedral sites face-shared with an XO₄ tetrahedron should be empty (FIG. 4). Thus, in synthesis, one should make sure that 4x≤4−(2+u−v)−(2−u) or xₘₐₓ=v/4 for a given v. In charging, v increases (vₘₐₓ=2+u), and in discharging, v decreases but there is often (if not always) a lower bound: vₘᵢₙ=4x for a given x.

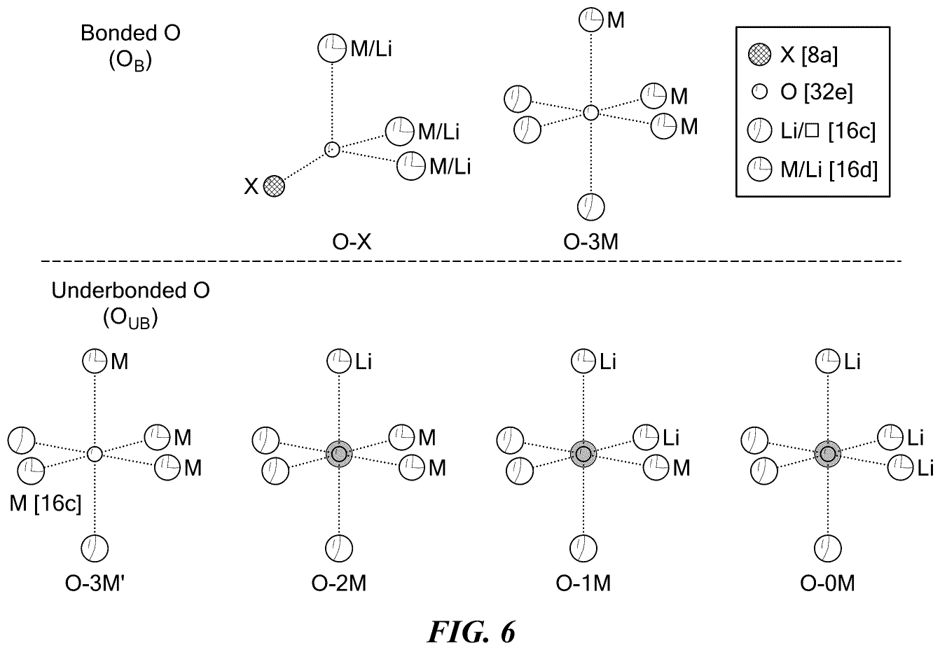

In relation to 0 stabilization: oxide ions can be classified into stable bonded oxygen (O_{B}) and labile underbonded oxygen (O_{UB}). O_{B} is considered as O bonded to three M cations in an octahedral complex (O-3M) or O belonging to the polyanion group (O—X, regardless of the number of M neighbors), and O_{UB} are O-2M, O-1M or O—0M (FIG. 6). For effective stabilization of HACR cathodes without long-range O diffusion/loss, O_{UB} needs to be non-percolating in the anion sublattice. The percolation threshold for an 3D FCC lattice is 0.2, and thus the O_{UB} ratio should be below 20% (or O_{B} ratio>80%).

In relation to M/O ratio, m: to enable high capacity and energy density, there should be sufficient high-symmetry lattice sites for full lithiation. Assuming that anion redox is active and the neighboring octahedral sites of an XO₄ tetrahedron can be electrochemically lithiated, the theoretical capacity of Li₂₊ᵤ₋ᵥM₂₋ᵤ[XO₄]ₓO₄₍₁₋ₓ₎ is limited by the M content only, as a maximum of (2+u) Li can be inserted. For layered cathodes LiMO₂ (M=Ni/Co/Mn, u=0), the theoretical capacity is around 280 mAh g⁻¹, with vₘᵢₙ=0. To reach higher capacities, one needs u>0 (also reduces molecular weight per formula unit). However, increasing u sacrifices the stability of the M-O framework with less O_{B} (only considering 0-3M for O_{B} and O-2M for O_{UB}, then O_{B} ratio=6m−2, where

$$m = \frac{2 - u}{4}$$

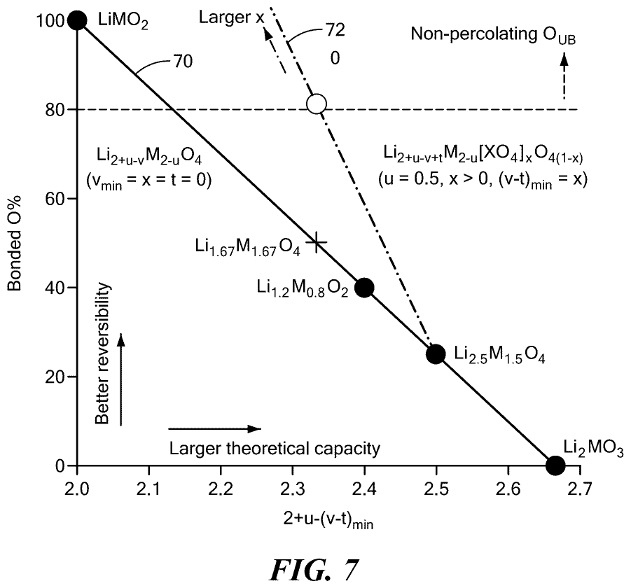

for cathodes without polyanion solid solution, line 70 in FIG. 7). The O_{B} ratio is only 0.4 for the stoichiometry, Li_{1.2}M_{0.8}O₂, of conventional Li-rich layered cathodes, which might explain their performance decay. Increasing u also increases the average M valence. For as-synthesized cathodes, Mn and Fe typically have a valence no more than +4 and +3, respectively, beyond which it is too oxidizing to be stable in air. These give an upper bound for U.

In relation to X/O ratio: the motivation for polyanion solid solution is to stabilize lattice oxygen and increase high voltage cyclability. As X strongly binds to its four first-nearest O via covalent bond, forming the XO₄ polyanion group in M₂₋ᵤ[XO₄]ₓO₄₍₁₋ₓ₎, the effective M/O ratio,

$$m = \frac{2 - u}{4 - 4 x} ,$$

is larger compared to the polyanion-free M₂₋ᵤO₄ with

$$m = \frac{2 - u}{4} ,$$

meaning a more robust structure with fewer labile O_{UB}. For effective stabilization with O_{UB} ratio kept below 0.2, a lower bound for x should exist, which is estimated in the following two limiting cases. First (i) without considering P—Li interactions and assuming evenly spaced Li and M at 16d sites and X at 8a sites, O_{UB} should only consist of G-2M, and GB consists of 0-3M and O—X. Let p be the population of a certain O configuration per formula unit Li₂₊ᵤ₋ᵥM₂₋ᵤ[XO₄]ₓO₄₍₁₋ₓ₎, resulting in p_{O-3M} (6m−2)(4−4x) and p_{O—X}=4x, and p_{O}_{_{B}}=p_{O-3M}+p_{O—X}≥4 (1−0.2) is required for stability. Solving for x x_{min,i}=0.5u−0.067. In reality, there may be certain amounts of O-1M or O-0M if Li/M short-range ordering (SRO) is considered, since the polyanion element with high positive valence prefers Li⁺ over Mn^{3+/4+} in its proximity to reduce (and ideally minimize) electrostatic repulsion. This makes p_{O-3M}>(6m−2) (4−4x) and thus a lower x_{min,i}.

Second (ii) assuming strong SRO (strong meaning x and Li are strongly attracted compared to other atom pairs in this structure) between X and Li, i.e., all u 16d Li octahedra are corner-shared with X tetrahedra (assuming the total number of 16d octahedra corner-shared with X tetrahedra, 12x, is greater than u, which is likely the case), then p_{O-0M}=0 and p_{O-1M}=u/2. Since p_{O-1M}+p_{O-2M}+p_{O-3M}=4−4x and p_{O-1M}+2p_{O-2M}+3p_{O-3M}=6m, accordingly p_{O-3M}=4+8x−5.5u. Also, p_{O—X}=4x and p_{O}_{_{B}} p_{O-3M}+p_{O—X}≥4 (1−0.2). Solving for x resultingly xmin, ii=0.458u−0.067.

The true xₘᵢₙ should lie between these two minima. Note that due to minor cation disorder between Mn at 16d and 16c sites (˜7% Mn at 16c sites for Li_{1.67}Mn_{1.5}P_{0.17}O₄), there is a small possibility of Li—O—Li configuration in O-3M′ complexes with Mn at 16c site (FIG. 6, bottom left), which can also lead to labile oxygen states. If you set f to be the fraction of Mn at 16c sites

$$( f = \frac{{n}_{MN [ 16 C ]}}{{n}_{MN [ 16 C ]} + {n}_{MN [ 16 D ]}} ,$$

n is the number of moles). The revised parameters are denoted with a ′ (prime symbol). The effective M/O ratio is then

$${m}^{′} = m \cdot ( 1 - f ) = \frac{2 - u}{4 - 4 x} ( 1 - f ) ,$$

and resulting in

$${x}_{min , i}^{′} = 0.5 u - 0.067 + ( 1 - 0.5 u ) f = {x}_{min , i} + ( 1 - 0.5 u ) f and$$

$${x}_{min , ii}^{′} = 0.458 u - 0.067 + ( 1 - 0.5 u ) f = {x}_{min , ii} + ( 1 - 0.5 u ) f .$$

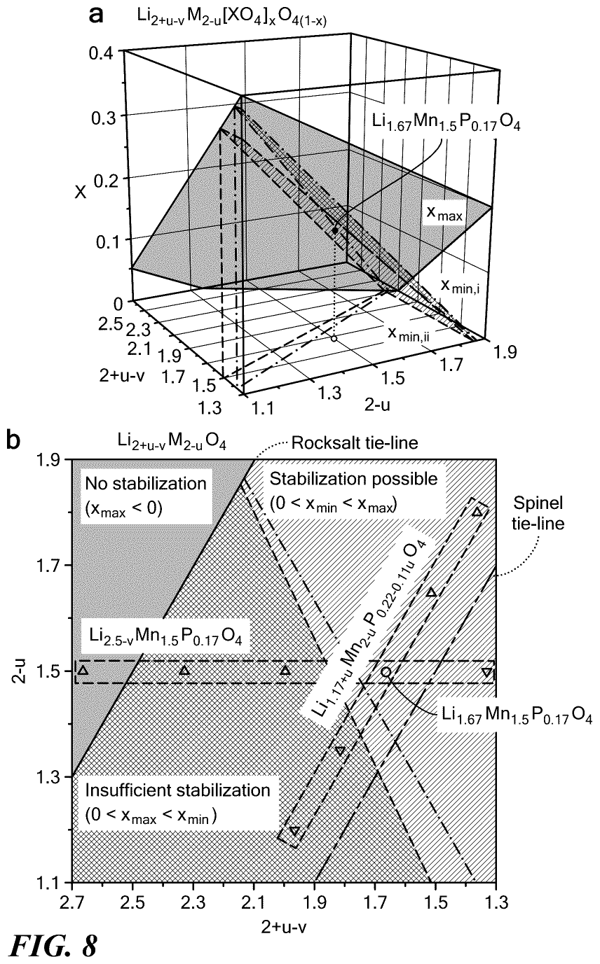

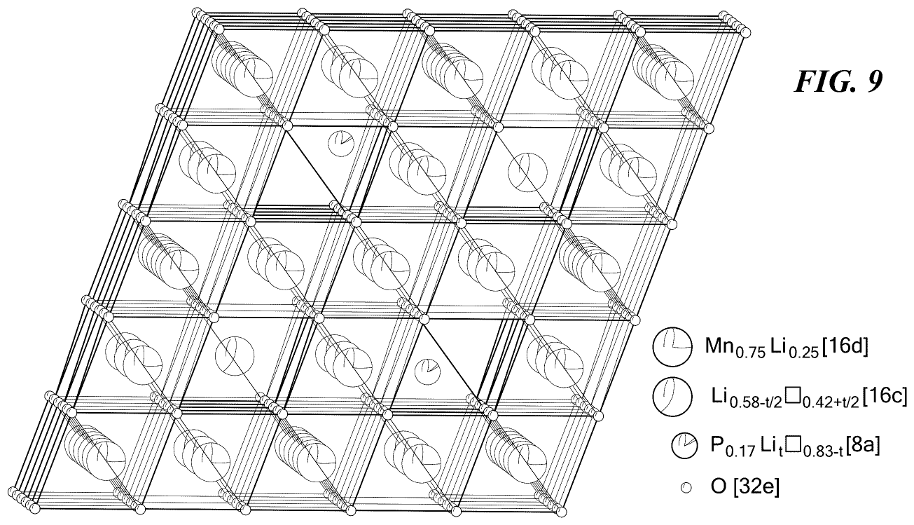

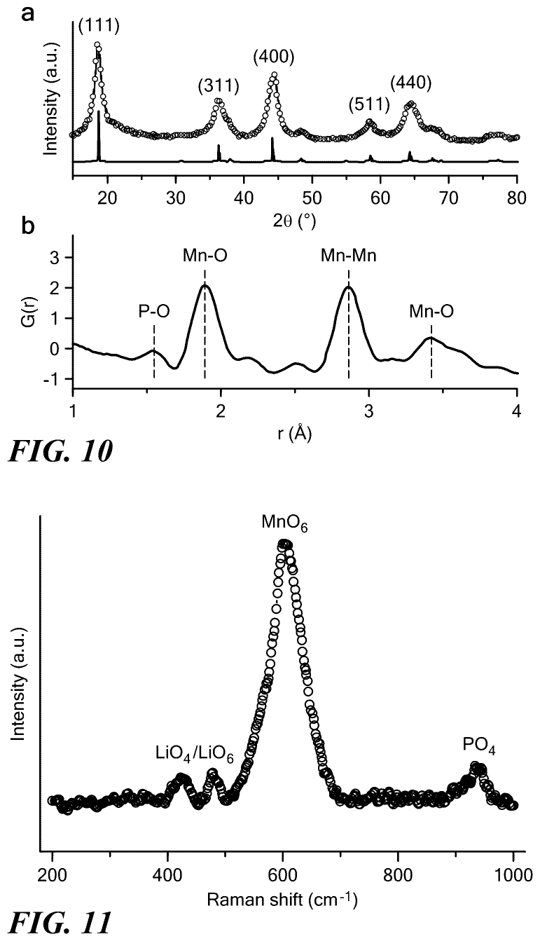

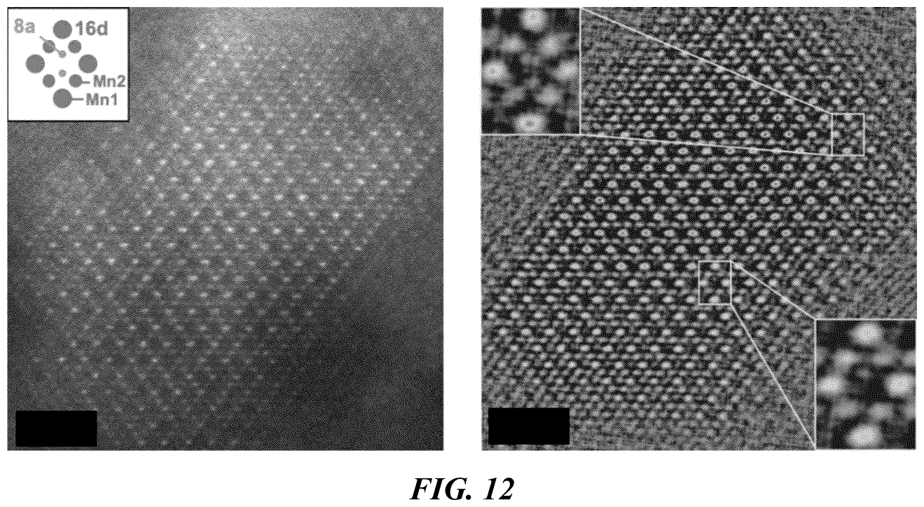

This calculation is a bit overshot since there is a small chance that all three 16c sites adjacent to an oxygen atom are occupied by Mn, which is a stabilized oxygen configuration, and thus the values should be between x and x′. The limits of x (assuming no cation disorder, i.e., Mn at 16c sites) are plotted in FIG. 8. In one embodiment, the cathode material has a composition of Li_{1.67}Mn_{1.5}P_{0.17}O₄ (M=Mn, X=P, u=0.5, v=0.83, x=0.17 in the general formula Li₂₊ᵤ₋ᵥ₊ₜM₂₋ᵤ[XO₄]ₓO₄₍₁₋ₓ₎). Li_{1.67}Mn_{1.5}P_{0.17}O₄ has a spinel structure represented by the structural model (FIG. 9). Per chemical formula Li_{1.67}Mn_{1.5}P_{0.17}O₄, 4 O at 32e sites forms the FCC anion framework, 1.5 Mn occupy ¾ of the 16d cation octahedral sites, and 0.17 P occupy ⅙ of the 8a cation tetrahedral sites. As 16d sites should be fully occupied for spinel, the remaining ¼ should be occupied by 0.5 Li, which leaves 1.17 Li that occupy either 8a or 16c sites. Therefore, using Q to denote cation vacancy (unoccupied tetrahedral/octahedral sites), one can write the structural model as (P_{0.17}Li_{t□0.83-t})₈ₐ(Li_{1.17-t□0.83+t})_{16c}(Li_{0.5}Mn_{1.5})_{16d}(O₄)₃₂ₑ. The spinel structure and atomic occupancies of Li_{1.67}Mn_{1.5}P_{0.17}O₄ can be justified by the X-ray diffraction (FIG. 10a), pair distribution function (FIG. 10b), Raman spectroscopy (FIG. 11), and high-resolution transmission electron microscopy data (FIG. 12).

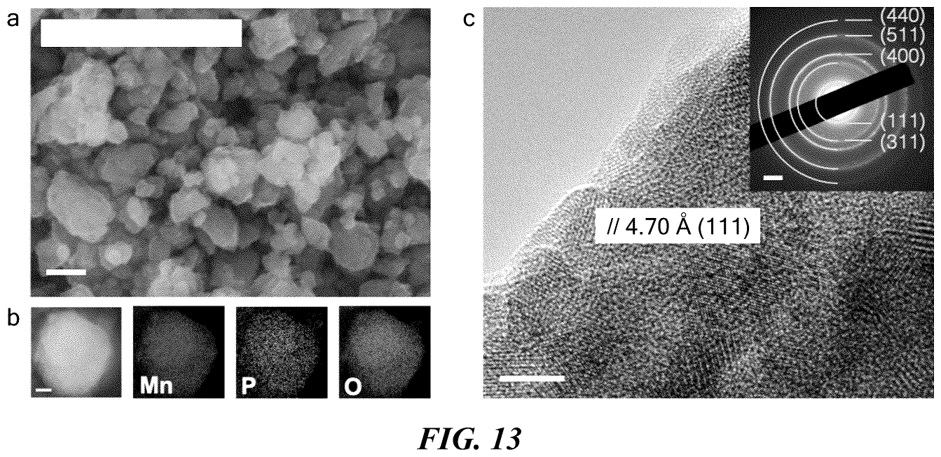

Scanning electron microscopy (SEM) in FIG. 13a shows that Li_{1.67}Mn_{1.5}P_{0.17}O₄ has a particle size of around 200 nm. The elements Mn, P, and O are uniformly distributed as shown by elemental dispersive spectroscopy (EDS) mapping (FIG. 13b). At a higher magnification, transmission electron microscopy (TEM) in FIG. 13c shows that the “particles” shown in SEM are polycrystalline in nature, which consist of “primary” particles in the sub-10 nm size regime. These primary particles are well crystallized and a characteristic lattice spacing d=4.68 Å can be identified, corresponding to the (111) plane of the spinel structure. The selected area electron diffraction (SAED) pattern (inset of FIG. 13c) further confirms the polycrystallinity, which shows diffraction rings corresponding to (111), (311), (400), (511) and (440) peaks from the inner to the outer.

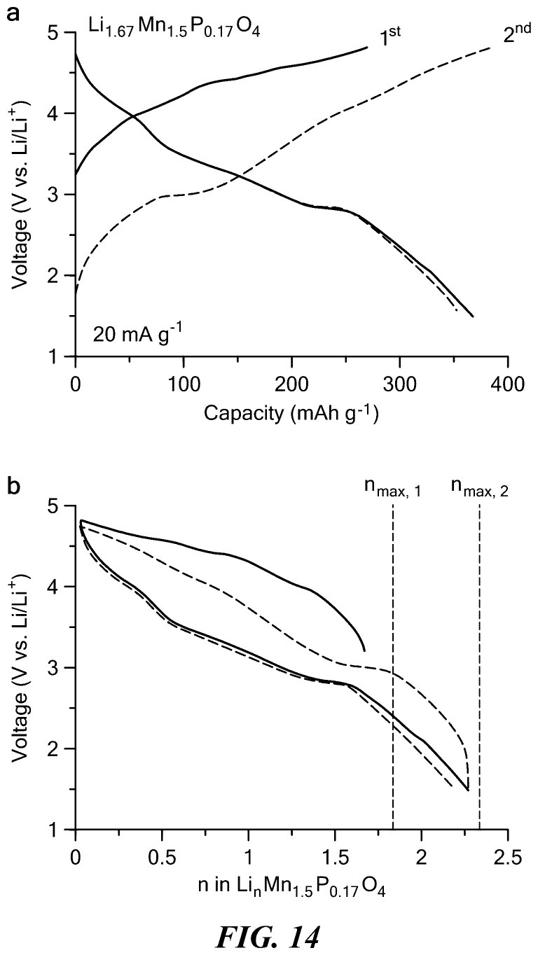

The electrochemical performance of Li_{1.67}Mn_{1.5}P_{0.17}O₄ is evaluated in coin-type half cells between 1.5-4.8 V vs. Li/Li⁺ at room temperature. FIG. 14a shows the galvanostatic charge-discharge curves of the first two cycles at 20 mA g⁻¹, which show high discharge capacities of ˜365 mAh g⁻¹ and high discharge energy densities of −1120 Wh kg⁻¹. Converting the capacity to stoichiometry, one can estimate a high Li usage of 1.63 Li removal (out of 1.67 Li) per formula unit (FIG. 14b) in the first charge. Since Mn in Li_{1.67}Mn_{1.5}P_{0.17}O₄ has an average valence of +3.67 (slightly lower Mn average valence may be possible depending on synthesis conditions) and Mn³⁺/Mn⁴⁺ can only charge-compensate for 0.5 Li removal, one would expect active participation of anion redox O²⁻/O^{α-} (0<α<2). During the first discharge, 2.23 Li was inserted into the structure, ending with an over-lithiated composition of Li_{2.27}Mn_{1.5}P_{0.17}O₄. The total amount of Li+Mn is 3.77 after discharge, which does not leave the 0.17 P tetrahedra with four face-shared octahedral vacancies (v=0.23=1.38x≤vₘᵢₙ=4x). This is possible only if the face-shared octahedral sites to the PO₄ tetrahedron (v=1.38x) or tetrahedral interstitials (v−t=1.38x) allow occupation of electrochemically inserted Li (otherwise the total Li+Mn should be below 4-4x=3.33). The over-lithiation should be charge-compensated by Mn reduction (oxygen loss during the first charge also results in Mn reduction). The second cycle shows a similar discharge curve to the first one, indicating high reversibility of the HACR charge-discharge process.

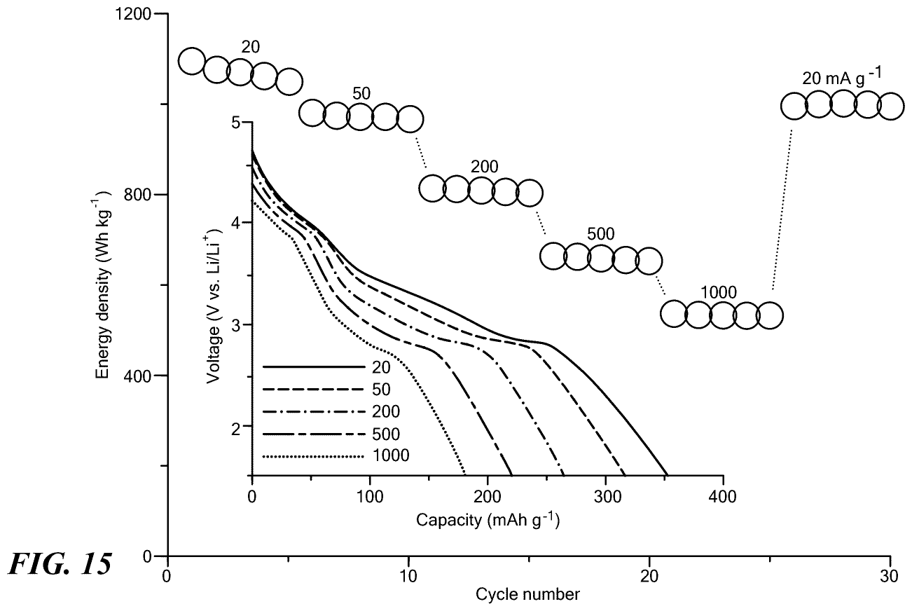

The rate performance of Li_{1.67}Mn_{1.5}P_{0.17}O₄ was tested from 20 mA g⁻¹ to 1000 mA g⁻¹ (˜5.5 C calculated from the charging time). FIG. 15 shows that the shapes of discharge voltage curves were well maintained upon increasing rates. Capacity retentions of 75% and 51% were observed when the galvanostatic current density increased from 20 mA g⁻¹ to 200 mA g⁻¹ and 1000 mA g⁻¹, respectively (FIG. 15).

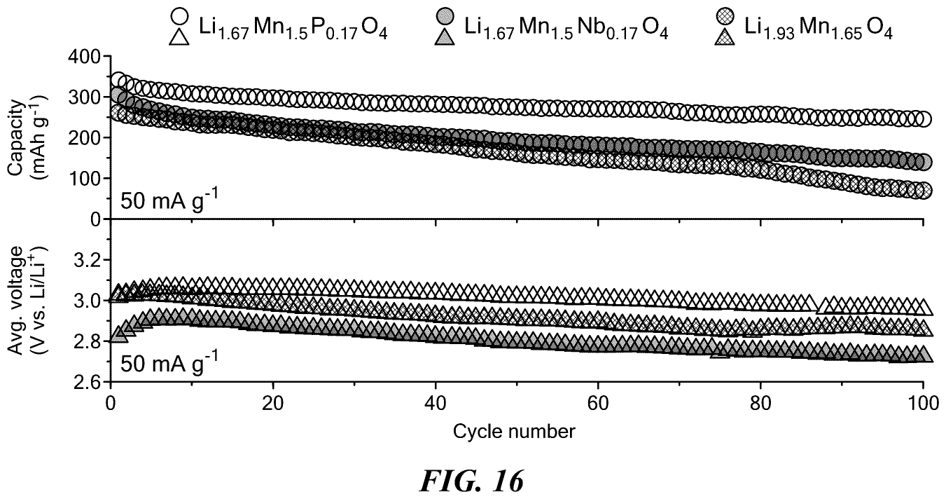

The cycling performance of Li_{1.67}Mn_{1.5}P_{0.17}O₄ was tested at 50 mA g⁻¹ after two formation cycles at 20 mA g⁻¹. A capacity retention of 72% (FIG. 16) and an energy density retention of 71% (FIG. 16) were maintained over 100 cycles (not counting the two formation cycles). For comparison, the cycling performance of similarly synthesized polyanion-free Li_{1.67}Mn_{1.5}Nb_{0.17}O₄ and Li_{1.93}Mn_{1.65}O₄ as control groups were tested and the results show faster degradations with 45%/27% capacity retention, and 44%/25% energy density retention after 100 cycles under the same testing conditions. The results demonstrate the superior stabilizing effect of this polyanionization solid-solution strategy.

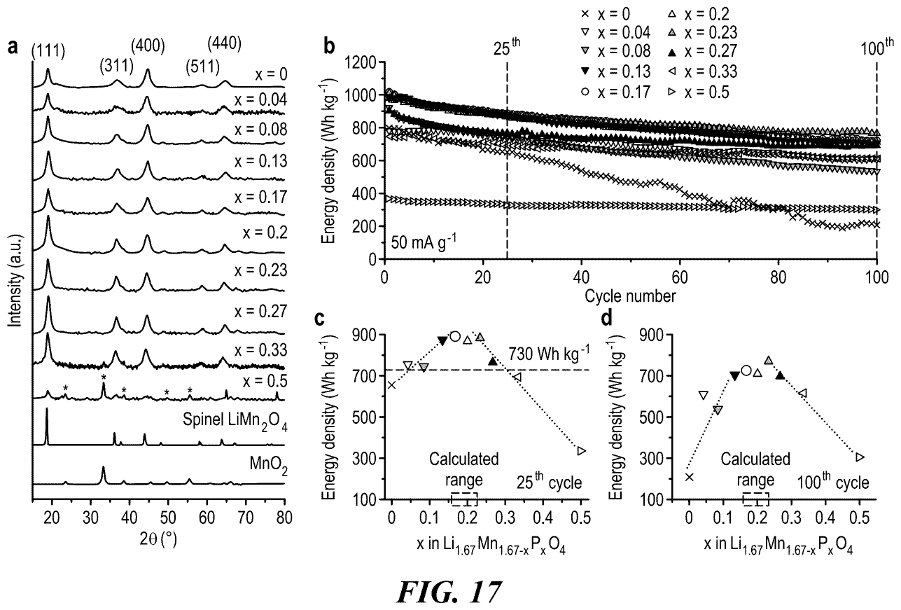

In some embodiments, the P content in Li_{1.67}Mn_{1.67-x}PₓO₄ is varied between 0≤x≤0.5. The XRD patterns of the synthesized compounds are shown in FIG. 17a. The results show that the phase-pure spinel structure readily forms at x≤0.27, while the impurity phase (from unreacted MnO₂ precursor) becomes apparent at x>0.33. The x=0.27 “solubility” limit (with supersaturated P) in mechanical alloying is slightly higher than the estimated xₘₐₓ=0.222 in Li_{1.67}Mn_{1.67-x}PₓO₄, suggesting that minor tetrahedral Li occupation or minor octahedral Li occupation face-shared with PO₄ tetrahedron are still possible, especially under far-from-equilibrium synthesis conditions. To evaluate the electrochemical performance, Li_{1.67}Mn_{1.67-x}PₓO₄ (0≤x≤0.5) is cycled between 1.5-4.8 V vs. Li/Li⁺ at 50 mA g⁻¹, after two formation cycles at 20 mA g⁻¹. As shown in FIG. 17b, PO₄ incorporation drastically improves the cycling stability over P-free Li_{1.67}Mn_{1.67}O₄ despite some differences in their ranking of initial discharge energy density and relative stability (x=0.27 gives much lower energy density). The optimal range of x is between about 0.13≤x≤0.23 (as shown FIG. 17c), which offers a stabilized energy density of 867-890 Wh kg⁻¹ at the 25^{th} cycle (see FIG. 17b). Likewise, the optimal range of x at the 100^{th} cycle is between about 0.13≤x≤0.23 (see FIG. 17d).

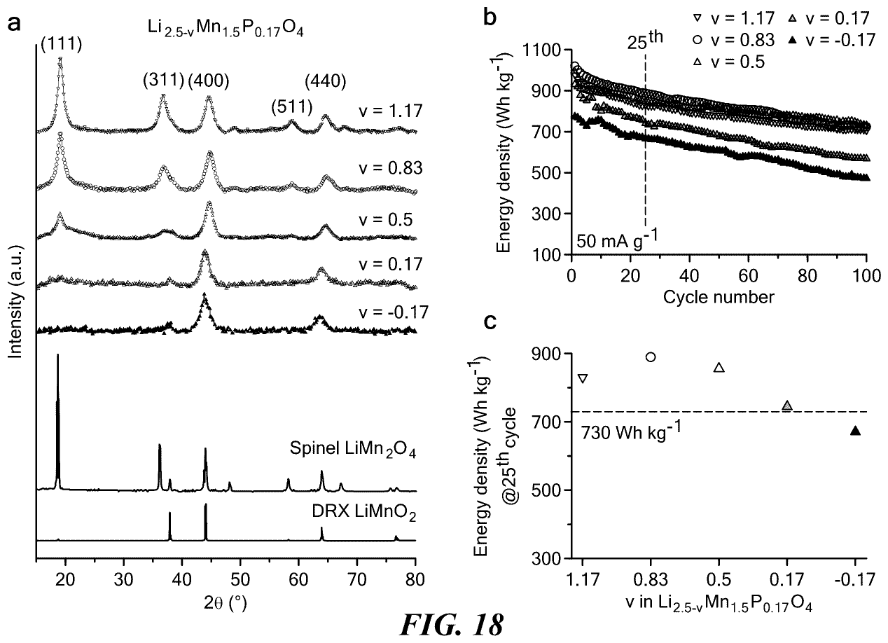

In some embodiments, the Li content and thus cation deficiency in Li_{2.5-v}Mn_{1.5}P_{0.17}O₄ is varied (v=−0.17, 0.17, 0.5, 0.83, 1.17), while the amounts of Mn (u=0.5) and P (x=0.17) are fixed. A high level of cation deficiency with 0.5≤v≤1.17 is found to be notably useful (in some embodiments, this may be critical) to the formation of the spinel phase (FIG. 18a), while larger v (less cation deficiency) results in rocksalt-type phase and eliminates the spinel-type cation ordering. Li_{2.5-v}Mn_{1.5}P_{0.17}O₄ (v=−0.17, 0.17, 0.5, 0.83, 1.17) is cycled between 1.5-4.8 V vs. Li/Li⁺ at 50 mA g⁻¹, after two formation cycles at 20 mA g⁻¹. As shown in FIG. 18b, while all polyanionized compositions show good cycling stability, the spinel-phase Li_{2.5-v}Mn_{1.5}P_{0.17}O₄ (v=0.5, 0.83, 1.17) leads to higher discharge energy density than the rocksalt ones (v=−0.17 and 0.17). The 25^{th}-cycle discharge energy densities are in the range of 830-890 Wh kg⁻¹ for the spinel phases (FIG. 18c), which are higher than the rocksalt ones and the 730 Wh kg⁻¹ benchmark. This proves the importance of the spinel phase and cation deficiency upon synthesis, as proposed in the design principles.

In some embodiments, the effective M/O ratio,

$$m = \frac{2 - u}{3.12 + 0.44 u} ,$$

is varied in Li_{1.17+u}Mn₂₋ᵤP_{0.22-0.11u}O₄ (u=0.2, 0.35, 0.5, 0.65, 0.8), such that the cation deficiency (v=0.83) and spinel order (molar ratio n_{Li+M}/n_{O}=0.79) are fixed. While some compositions exhibit a spinel-like phase (FIG. 19a), their cycling performances differ. Compositions with intermediate u (u=0.35, 0.5 and 0.65, especially u=0.5) having an initial energy density which is higher than the initial energy densities of the other compositions shown in FIG. 19B and which have a decay which results in energy densities at the 25^{th} cycle which are higher than the other compositions shown in FIG. 19B. Thus, compositions with intermediate u values are preferred. Their 25^{th}-cycle discharge energy densities show an optimal value is about 0.5 (as can be seen in FIG. 19C). This justifies the design principle that the M/O ratio should be a compromise between capacity and structural stability (while ensuring phase-pure synthesis). Generally speaking, to achieve high capacity and energy density, an effective M/O ratio down to 0.4 (FIG. 19c) can be accepted that does not sacrifice cycling stability too much. This is between that of layered LiMO₂ (m=0.5) and Li-rich Li₂MnO₃ (m=0.33).

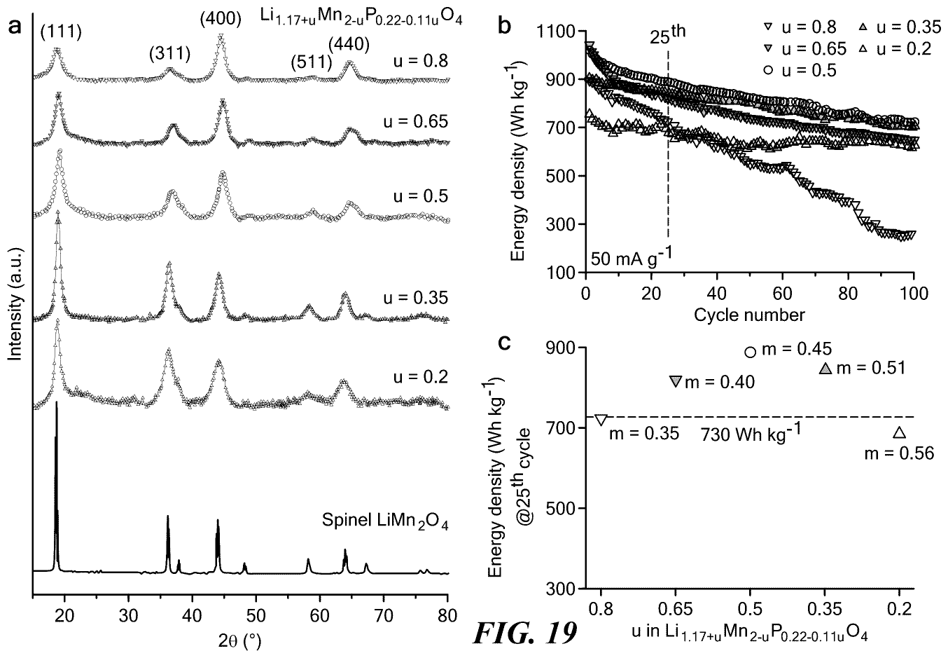

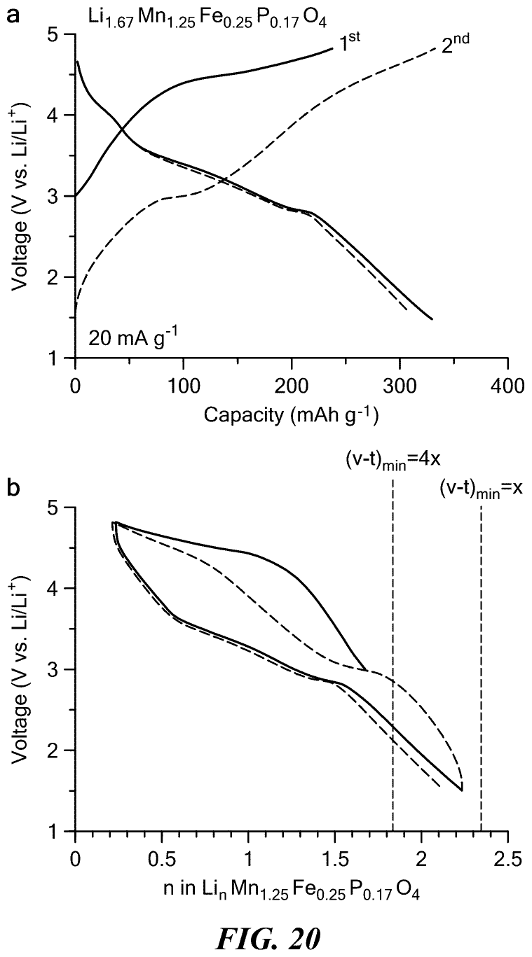

In some embodiments, Fe is mixed with Mn to form Li_{1.67}Mn_{1.25}Fe_{0.25}P_{0.17}O₄ and Li_{1.67}MnFe_{0.5}P_{0.17}O₄. The electrochemical performance of Li_{1.67}Mn_{1.25}Fe_{0.25}P_{0.17}O₄ is tested between 1.5-4.8 V vs. Li/Li⁺ at room temperature. In the first cycle at 20 mA g⁻¹ (FIG. 20a), it shows a discharge capacity of 327 mAh g⁻¹ and a discharge energy density of 978 Wh kg⁻¹, which are slightly lower than the corresponding values for Li_{1.67}Mn_{1.5}P_{0.17}O₄. Converting the capacity to stoichiometry (FIG. 20b) indicates that 1.43 Li out of 1.67 can be extracted in the first charge, which again suggests active anion redox. During the first discharge, 2 Li can be inserted, ending with an over-lithiated composition of Li_{2.24}Mn_{1.25}Fe_{0.25}P_{0.17}O₄, which can be reversibly utilized in the subsequent cycle.

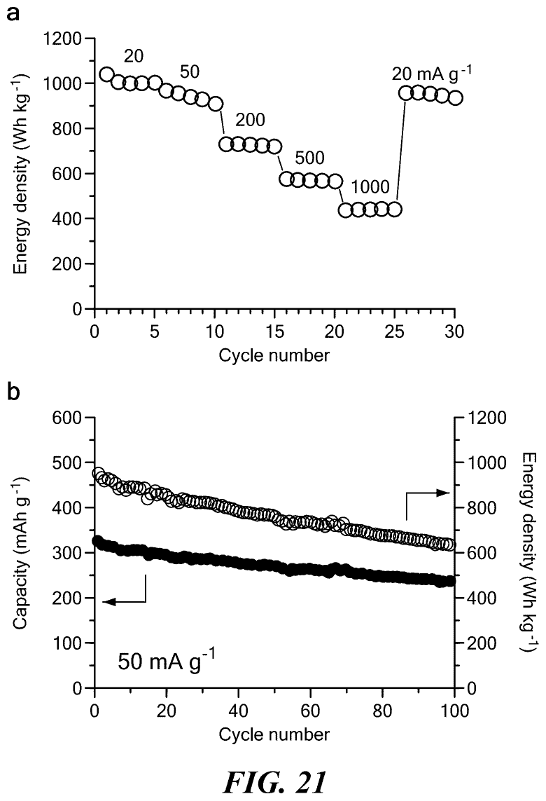

FIG. 21a shows the rate performance of Li_{1.67}Mn_{1.25}Fe_{0.25}P_{0.17}O₄, with ˜74% and ˜47% capacity retentions when the current density increases from 20 mA g⁻¹ to 200 mA g⁻¹ and 1000 mA g⁻¹, respectively. Li_{1.67}Mn_{1.25}Fe_{0.25}P_{0.17}O₄ also shows exceptional cycling performance, with 72% capacity retention and 67% energy density retention (FIG. 21b) over 100 cycles at 50 mA g 1.

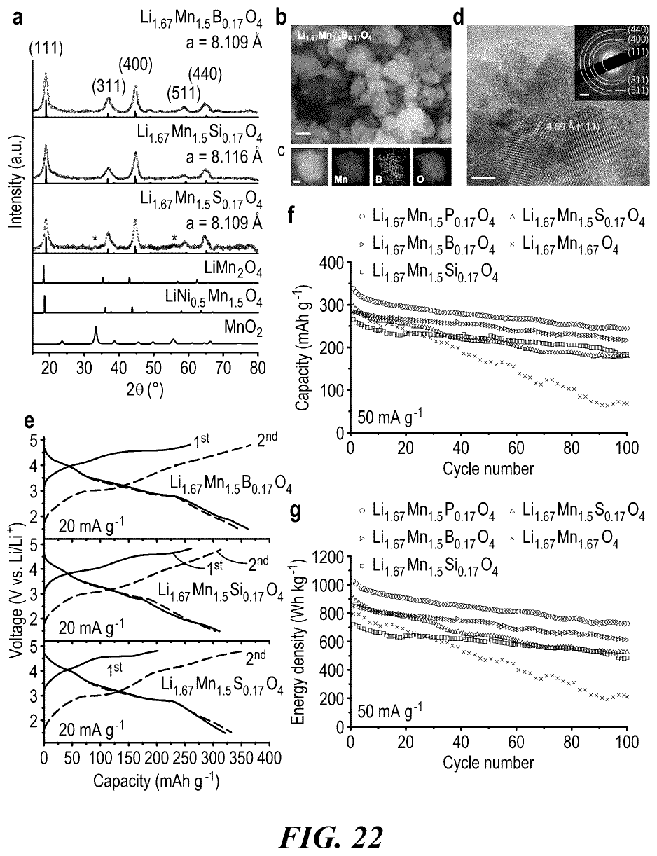

In some embodiments, X in Li_{1.67}Mn_{1.5}X_{0.17}O₄ is varied with X being +3 B, +4 Si, and +6 S. These nonmetal elements all form strong covalent bonds with oxygen and adopt tetrahedral occupancy (i.e., forming XO₄ groups). As shown by the XRD patterns in FIG. 22a, phase-pure spinel structures have been identified for Li_{1.67}Mn_{1.5}B_{0.17}O₄ and Li_{1.67}Mn_{1.5}Si_{0.17}O₄, while minor impurity peaks matching MnO₂ (precursor) exists in Li_{1.67}Mn_{1.5}S_{0.17}O₄ in addition to the main spinel phase. A similar structural model (X_{0.17}Li_{t□0.83-t})8a(Li_{1.17-t□0.83+t})16c(Li_{0.5}Mn_{1.5})16d(O₄)32e to that of Li_{1.67}Mn_{1.5}P_{0.17}O₄ is consistent with the XRD data. Microscopy characterizations in FIG. 22b-d of a selected composition Li_{1.67}Mn_{1.5}B_{0.17}O₄ show a polycrystalline particle morphology with ultrafine primary ones that are well crystalized and in the spinel phase.

The electrochemical performance of Li_{1.67}Mn_{1.5}X_{0.17}O₄ was tested between 1.5-4.8 V vs. Li/Li⁺ at room temperature. FIG. 22e shows the galvanostatic charge-discharge curves of the first two cycles at 20 mA g⁻¹ for Li_{1.67}Mn_{1.5}B_{0.17}O₄. Li_{1.67}Mn_{1.5}Si_{0.17}O₄, and Li_{1.67}Mn_{1.5}S_{0.17}O₄, respectively. Among the three compositions, Li_{1.67}Mn_{1.5}B_{0.17}O₄ has the highest discharge capacity of ˜360 mAh g⁻¹ and the highest discharge energy density of ˜1070 Wh kg⁻¹, which are comparable with the corresponding values of Li_{1.67}Mn_{1.5}P_{0.17}O₄. When cycled at a higher rate of 50 mA g⁻¹, good cycling stability can be identified and the discharge energy density at the 25th cycle (after two formation cycles) follows the rank of Li_{1.67}Mn_{1.5}P_{0.17}O₄>Li_{1.67}Mn_{1.5}B_{0.17}O₄>Li_{1.67}Mn_{1.5}S_{0.17}O₄>Li_{1.67}Mn_{1.5}Si_{0.17}O₄ (FIG. 22f,g). Nevertheless, these compositions all show great improvements over the polyanion-free spinel Li_{1.67}Mn_{1.67}O₄. Therefore, the results show that polyanionization is a methodology to improve the stability of high-energy-density oxide cathodes and diverse polyanions can be considered in the materials design.

In one embodiment, the compositions may be synthesized using a one-pot low-temperature mechanochemical synthesis method. Li₂O, Mn₂O₃, MnO₂, Li₃PO₄, Fe₂O₃, B₂O₃, Li₂SO₄ and SiO₂ (all from Sigma-Aldrich, 99% purity) precursors are directly mixed using a planetary ball mill, according to stoichiometry (e.g., Li_{1.67}Mn_{1.5}P_{0.17}O₄=0.58 Li₂O+0.25 Mn₂O₃+MnO₂+0.17 Li₃PO₄). Precursor powders with a total weight of around 5 g were put into an 80 ml stainless steel jar, with 25 10-mm-diameter stainless steel balls (weight ratio of powders to balls was 1:20), and mixed in air under 800 rpm for 5 hours. No additional heat treatment was involved.

To prepare a cathode film for electrochemical testing, 70 wt % cathode active material powder, 20 wt % conductive carbon (Timcal Super C65), and 10 wt % polyvinylidene fluoride (PVDF, Sigma Aldrich) dissolved in N-methyl-2-pyrrolidone (NMP, Sigma Aldrich) solvent are mixed to form a slurry, which is then cast onto an aluminum foil using a doctor blade. A polypropylene (PP, Celgard 2400) membrane is used as the separator. 1.2M LiPF₆ dissolved in ethylene carbonate (EC): ethyl methyl carbonate (EMC)=30:70 wt % solution (Gotion) is used as the electrolyte. Li metal foil is used as the counter and reference electrode. Coin-type cells (CR2032) are assembled in an argon-filled glove box (MBraun). Electrochemical testing of the coin cells is conducted on a Landt CT2001A battery tester (Wuhan Lanhe Electronics) at room temperature.

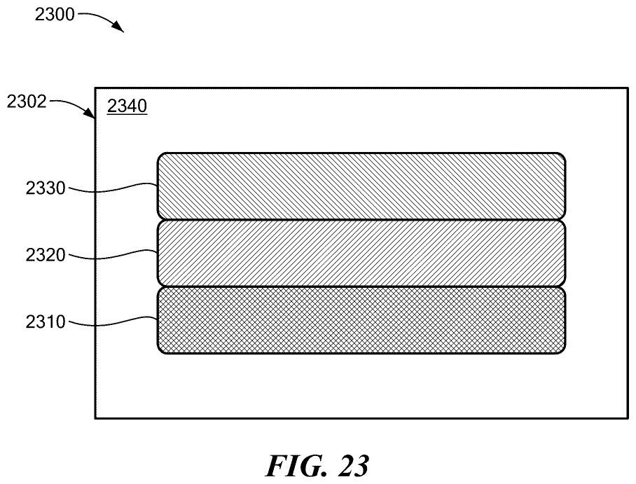

FIG. 23 is an exemplary schematic of a battery 2300 including the disclosed cathode. A separator layer 2320 is disposed on an anode 2310. A cathode 2330 is disposed on the separator layer 2320. The separator layer 2320 separates the cathode 2330 and the anode 2310. The separator layer 2320, the cathode 2330, and the anode 2310 are immersed in the electrolyte 2340. The separator layer 2320, the cathode 2330, the anode 2310, and the electrolyte 2340 are contained in the cell case 2302. The cathode comprises Li₂₊ᵤ₋ᵥM₂₋ᵤ[XO₄]ₓO₄₍₁₋ₓ₎ where, 0≤u≤1, 0≤v≤2 and 0≤x≤1, wherein M is a transition metal element of manganese or a mixture of manganese and iron, and X is an element of phosphorus, silicon, sulfur, boron, or a mixture of these elements; an electrolyte; and an anode. In an embodiment, the electrolyte is lithium hexafluorophosphate dissolved in ethyl methyl carbonate.

Many modifications and variations of the present disclosure are possible in light of the above teachings. It is, therefore, to be understood within the scope of the appended claims the disclosure may be protected otherwise than as specifically described.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. It should be noted that the term “selective to, “such as, for example, “a first element selective to a second element,” means that the first element can be etched and the second element can act as an etch stop.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

We claim:

1. A cathode for a lithium-ion battery comprising:
Li₂₊ᵤ₋ᵥM₂₋ᵤ[XO₄]ₓO_{4 (1-x)} where, 0≤u≤1, 0≤v≤2 and 0≤x≤1, wherein M is a transition metal element of manganese or a mixture of manganese and iron, and X is an element of phosphorus, silicon, sulfur, boron, or a mixture of these elements.

2. The cathode of claim 1 wherein the cathode has a spinel structure.

3. The cathode of claim 1 wherein M is a mixture of manganese and iron.

4. The cathode of claim 1 is free of cobalt and nickel.

5. The cathode of claim 1 wherein M is manganese.

6. The cathode of claim 1 wherein X is phosphorous.

7. The cathode of claim 1 wherein X is silicon.

8. The cathode of claim 1 wherein X is sulfur.

9. The cathode of claim 1 wherein X is boron.

10. The cathode of claim 1 wherein X is a mixture of phosphorus, silicon, sulfur and boron.

11. The cathode of claim 1 wherein 0.458u−0.067≤x≤v/4.

12. The cathode of claim 11 is Li_{1.67}Mn_{1.5}P_{0.17}O₄.

13. The cathode of claim 11 is Li_{1.67}Mn_{1.25}Fe_{0.25}P_{0.17}O₄.

14. The cathode of claim 11 is Li_{1.67}Mn_{1.5}B_{0.17}O₄.

15. The cathode of claim 11 is Li_{1.67}Mn_{1.5}Si_{0.17}O₄.

16. The cathode of claim 11 is Li_{1.67}Mn_{1.43}P_{0.23}O₄.

17. The cathode of claim 11 is Li_{1.67}Mn_{1.47}P_{0.2}O₄.

18. A battery comprising:
a cathode comprising Li₂₊ᵤ₋ᵥM₂₋ᵤ[XO₄]ₓO₄₍₁₋ₓ₎ where, 0≤u≤1, 0≤v≤2 and 0≤x≤1 wherein M is a transition metal element of manganese or a mixture of manganese and iron, and X is an element of phosphorus, silicon, sulfur, boron, or a mixture of these elements; a separator;
an electrolyte;
an anode; and a cell case.

19. The battery of claim 18 wherein the electrolyte is lithium hexafluorophosphate dissolved in ethyl methyl carbonate.

20. A method of preparing a cathode material comprising:
providing ingredients of Li₂O, Mn₂O₃, MnO₂, Li₃PO₄, Fe₂O₃, B₂O₃, Li₂SO₄ and SiO₂:
mixing the ingredients in a mixer for a sufficient period to form Li₂₊ᵤ₋ᵥM₂₋ᵤ[XO₄]ₓO₄₍₁₋ₓ₎ where, 0≤u≤1, 0≤v≤2 and 0≤x≤1, wherein M is a transition metal element of manganese of a mixture of manganese and iron, and X is an element of phosphorus, silicon, sulfur, boron, or a mixture of these elements.
